(19) United States
(12) Patent Application Publication
(10) Pub. No.: US 2013/0151160 A1
(43) Pub. Date: Jun. 13, 2013

(54) METHOD FOR DETERMINING THE STRESS-STRAIN STATE OF A STRATIFIED MEDIUM

(71) Applicant: Maxim Andreevich Chertov, Salt Lake City, UT (US)

(72) Inventor: Maxim Andreevich Chertov, Salt Lake City, UT (US)

(73) Assignee: SCHLUMBERGER TECHNOLOGY CORPORATION, Sugar Land, TX (US)

(21) Appl. No.: 13/701,447

(22) PCT Filed: Jun. 8, 2010
(86) PCT No.: PCT/RU2010/000299

§ 371 Date: Feb. 13, 2013

(51) Int. Cl. G01V 9/00; G06F 17/00

(52) U.S. Cl. CPC G01V 9/00; G06F 17/00
USPC 702/11

(57) ABSTRACT

The disclosure is related to methods for determining a stress-deformed state of layered media having at least one fluid-filled poroelastic layer induced by fluid pressure changes and it can be used in oil & gas industry. The method comprises determining initial parameters of a layered medium and a volume-distributed loading of developed layers of the layered medium. Then a set of equations is specified including elastic balance equations for each layer and equations defining boundary conditions between the layers. Analytical solutions of the elastic balance equations for each layer are obtained and adjusted to satisfy boundary conditions between the layers. Displacements and stresses in any point of the layered medium are determined in accordance with a required approximation accuracy on basis of the adjusted analytical solutions.

### FIELD OF THE DISCLOSURE

The disclosure is related to methods for determining a stress-deformed state of layered media having at least one fluid-filled poroelastic layer induced by fluid pressure changes. This disclosure may be used for wide range of media, and in particular, for composite materials, geological formations and bone tissues.

### BACKGROUND OF THE DISCLOSURE

“Poroelastic” layers are layers having a porous (with pores, cavities) and elastic medium.

Thus, filling of a poroelastic layer implies filling any such cavity with a fluid. Particularly, the fluid may fill pores, fractures in the layer, cavities, caverns, etc. The fluid may particularly be water, crude oil, etc. Natural gas, air or any other gaseous substance may also be considered as fluid.

The method may be used in oil & gas industry, particularly for determining stress-deformed state of a layered geologic formation characterized by stress and displacement distribution induced by pore pressure changes during natural oil & gas field development (injection, production wells).

The disclosed method provides for determining stress-deformed state of a layered medium with high speed and accuracy.

In oil & gas industry, uncontrolled deformations and stress changes can result in numerous problems including casing failure, well collapse, sanding, loss of permeability, etc. Therefore, field development should be controlled by constant monitoring of rock deformations and stress changes.

The disclosed method can be used for screening purposes to preliminarily estimate the risk of large deformations and decide if a full scale 3D simulation is necessary. This method can also be used to perform quick parameter changes, sensitivity analyses, history matching or to invert displacement and stress measurements to get information about the reservoir state. Among other benefits, fast prediction of displacement and stress changes in the reservoir allows early investment planning.

In the prior art there are methods that predict various reservoir geomechanics processes connected with changes of stresses, strains, pressures and permeabilities using coupled simulations by finite-definite or finite-element mechanical and hydrodynamical codes, either commercial or in-house, in particular:
P. Longuemare, M. Mainguy, P. Lemonnier, A. Onaisi, Ch. Gerard, N. Koutsabeloulis, Geomechanics in field stimulation: overview of coupling methods and field case study, Oil & gas science and technology—Rev. IFP., Vol. 57 No. 5, pp. 471-483, 2002;
Settari, F. M. Mourits. A Coupled Field and Geomechanical Simulation System, SPE Journal, pp. 219-226, 1998, 219-226, 1998);
Coupled geomechanics and field simulation, SPE-87339-PA, 2003;
P. Samier, S. De Gennaro, Practical iterative coupling of geomechanics with field simulation. SPE-106188, 2007;
U.S. Pat. No. 7,177,764 B2, G01V11/00, publ. Oct. 7, 2004.

All of these methods are based on approximation of the simulated problem using a discrete mesh, which provides a lot of flexibility to model different reservoir configuration and refine approximation.

However, application of these methods may become very time consuming both concerning running of calculations and preparation of the numerical model.

There is also a variety of semi-analytic models. Generally in these models derivation are made to calculate only a geological formation subsidence caused by fluid extraction from collector, that is, a vertical displacement at the surface. Other components of displacements and stress tensor are not provided, although they often can be derived within the framework of most of the methods.

Thus, a well known semi-analytic model in the oil industry is the method of point deformation sources. See J. Geertsma, Land subsidence over compacting oil and gas reservoirs, J. Pet. Tech. Vol. 25, pp. 734-744, 1973). In this method, a 3D depleted area is decomposed into a set of small cubic-shaped sources of deformation. Contribution from each source into a subsidence is calculated using the analytical solution for a single point source of deformation embedded into semi-infinite elastic domain. This elementary solution is applicable at large distance compared to the size of the source and therefore the method cannot calculate displacements inside the depleted area itself. This method is inapplicable, however, when the reservoir and surrounding rocks have different elasticity.

A method of subsidence calculation by the so called Bruno formula is also know, see M. S. Bruno, Geomechanical analysis and decision analysis for mitigating compaction related casing damage, SPE 71695, 2001.5PE 71695, 2001). This formula allows calculation of maximum subsidence above a disk-shaped reservoir.

Use of ring-shaped source functions to model stress changes around axisymmetric reservoirs in uniform elastic half-space is known from Segall P., Induced stresses due to fluid extraction from axisymmetric fields. Pure Appl. Geophys. 139, 3/4, pp. 535-560, 1992.

Use of fictitious sources of different type (point force, dipole, and spherical sources) to compensate displacement mismatch on the interfaces between layers with elastic contrast is known from P. A. Fokker, B. Orlic, Semi-analytic modeling of subsidence, Mathematical Geology, Vol. 38, No. 5, pp. 565-589, 2006.

This method is also inapplicable to calculate displacements inside the depleted area and requires additional calibration and tuning to select number, positions and strengths of fictitious sources to obtain acceptable match in displacements on the interfaces.

Thus, the known methods have limited technical abilities and either do not allow to measure stress and displacement changes in geologic formations with sufficient completeness and accuracy or do not provide required computation speed.

### SUMMARY OF THE DISCLOSURE

The disclosed method provides very fast estimation of stress and displacement changes in 3D layered poroelastic geologic formation induced by pore pressure changes.

The disclosed method comprises: a) determining initial parameters of a layered medium, b) determining a volume-distributed loading of developed layers of the layered medium, c) specifying a set of equations including elastic balance equations for each layer and equations defining boundary conditions between the layers: continuity of tractions between the layers, zero tractions at free boundary, zero displacements at infinity, d) obtaining analytical solutions of the elastic balance equations for each layer provided that the layers are plane-parallel, homogenous and poroelastic, e) adjusting the analytical solutions obtained for the layers to satisfy boundary conditions between the layers, f) determining displacements and stresses in any point of the layered medium in accordance with a required approximation accuracy on basis of the adjusted analytical solutions.

According to possible embodiments of the method:

The initial parameters comprise layers geologic parameters.

The layers geologic parameters comprise Lame elastic parameters (λ, μ), Biot poroelastic constant, a thickness of a layer.

The geologic parameters are determined by means of measuring tools or empirically or both, or are selected in dependence of a current task.

The volume-distributed loading is determined through a pore pressure gradient of the layer being developed.

The pore pressure is calculated by solving a piezoconductivity equation with a semi-analytic hydrodynamic method.

Steps d) and e) are realized in Cartesian coordinates or cylindrical coordinates.

Additionally the obtained stresses and displacements can be visualized.

### BRIEF DESCRIPTION OF THE DRAWINGS

FIG. 1 shows main steps and intermediate data records of LGM+GREAT coupled reservoir geomechanics simulation;

FIG. 2 shows a cross section of the layered 3D field;

FIG. 3 shows a flowchart of the LGM algorithm calculation steps;

FIG. 4 shows a box-shaped reservoir with grid of sensor wells embedded into surrounding elastic rock;

FIG. 5 shows a flowchart of one-way coupled LGM+GREAT calculation.

FIG. 6 shows a modelled task with five-pointed development plan in two-layered collector.

FIG. 7 shows distribution of vertical displacement values U_{z} at the upper developed layer's upper bound at z=6800 feet depth.

FIG. 8 shows distribution of normal horizontal tensions values σₓₓ at z=6850 feet depth.

### DETAILED DESCRIPTION

At first, initial parameters of a layered medium, in particular geologic parameters characterizing properties and state of a formation, are measured.

It should be noted that the main assumption, which was used to design the disclosed semi-analytic geomechanical engine, is that the layered medium is a stack of horizontal plane parallel layers, where each layer is homogenous and poroelastic. It is further referred as the Layered Geomechanical Model (LGM).

Layers restricted by parallel horizontal planes on both sides are considered to be “plane parallel.”

“Poroelastic” is a layer consisting of porous (for example, containing evenly distributed interconnected pores) and elastic (continuously distributed in the space and having elastic properties) medium. Such medium is characterized by elastic modules λ, μ (Lame's parameters), Biot's poroelastic parameter α and a thickness (d) of each layer. These parameters form the geologic parameters.

A layer having its properties constant (value=const) along the whole length of the layer is considered to be “homogenous.”

A volume-distributed loading means a pore pressure distribution during withdrawal or injection of fluids through injection or production wells.

Geologic parameters can be directly measured by known tools and methods used for similar measurements in oil & gas industry. These tools for instance include sensors distributed in section zones, seismic and acoustic gauges, dipmeters and other borehole measuring equipment. Thus, a thickness (d) of a layer is measured as a distance between lithologic boundaries visible as values jumps on well logs of different nature; elastic modules (λ), (μ) can be measured on basis of acoustic logging analysis; Biot's poro elastic parameter (α) can be evaluated by means of laboratory mechanical tests of recovered core sample.

The geologic parameters can also be determined on the basis of existing knowledge, i.e. empirically or by selecting them in dependence of current task requirements.

Then, the LGM of a field is created, namely a full solution for 3D layered medium. Such model is described by a set of equations characterizing elastic stress-deformed state of balance for each layer, i.e., internal tractions and deformations caused by external actions, and also equations defining boundary conditions at layers boundaries (between the layers and also at the top and bottom boundaries of the layers).

The top surface of a top-most layer is free of tractions, and the bottom layer is semi-infinitely thick with zero displacements at infinity. Lateral boundary conditions are zero displacements at infinity. Boundary conditions between the layers are continuity of tractions acting to surface element of interface bound (bound of section), and vertical displacements. Tangential displacements between the layers are proportional to the normal stress acting in the same direction multiplied by compliance coefficients specified during LGM creating. By default, this compliance is equal to zero representing perfectly bonded layers.

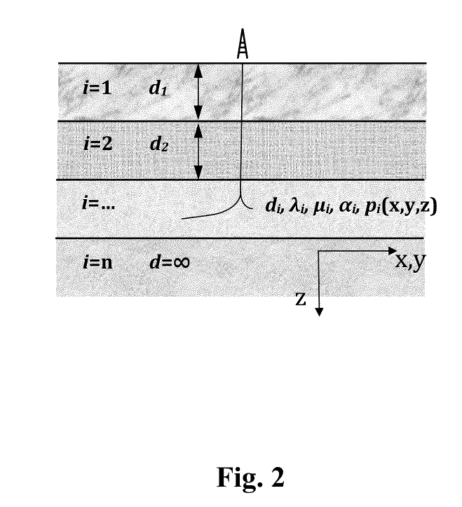

Each separate poroelastic layer may have an independently specified profile of volume-distributed loading changes which is defined by fluid pressure p(x, y, z) inside it. This pressure profile is presented as a horizontal component of pressure that changes like arbitrary function of X and Y, multiplied by a vertical component, which is a 3^{rd} order polynomial function of z. The above mentioned constraints on geometry and parameters of the model are necessary to formulate the fast semi-analytic solution method. In the following, layers are numbered from top to bottom i=1 . . . n and the z coordinate is directed downwards (see FIG. 2).

Then analytical solutions of said equations are obtained and adjusted between each other to satisfy boundary conditions and then to determine displacements and stresses. It should be noted that in case when equations are presented in an invariant form, and obtaining of their analytic solutions is realized for instance in Cartesian or cylindrical coordinates, it is necessary to make relevant replacement and to replace differentiation operators in invariant form by their coordinate representation.

Calculation of the displacements and stresses inside the layered half-space is performed with the use of a 2-dimensional Fourier transform. Finally, the total solution is transformed back to real space to yield displacements and stresses. It is also possible to visualize the obtained values.

Well-known tools for appropriate mathematical treatment are used as tools that realize generation of equations, obtaining of analytic solutions, their adjustment and obtaining of final results. Computers that support mathematic calculations of real numbers with floating point, to which particularly belong Intel-compatible computers of x86 architecture applicable as such tools. It is possible to use computers that support calculations with floating point and other architectures.

As visualization tools allow converting obtained values into visual images of required format, different software products can be used that realize graphic visualization of mathematic data, setup and run on computers provided with tools of information graphic mapping, for instance computer display. As some examples of such software products, Gnuplot, Techplot, Microsoft Excel, Matlab may be mentioned.

In our case approximation accuracy depends on how many discrete points are used for approximation of continuous functions that we calculate using the disclosed method.

It should be noted that pore pressure distribution information can be obtained from external sources, i.e., be calculated by any of the known methods or settled empirically. At the same time it is also possible to use different finite-difference and finite-element calculation methods for pressure calculation, or pressure distributions import in manual mode.

According to one of the embodiments pressure changes are calculated in accordance with a semi-analytic method of gas reservoir evaluation (Gas Field Evaluation and Assessment Tool), hereafter—GREAT (see U.S. Pat. No. 7,069,148 B2, k. G 06 F 19/00, publ. 27.06.2006; J. G. Busswell, R. Banerjee, R. K. M. Thambynayagam, J. Spath, Generalized analytical solution for field problems with multiple wells and boundary conditions, SPE-99288, 2006). The method is based on use of original expressions for analytic solution of piezoconductivity equation for monophase system with homogeneous diffusion coefficients and allows obtaining this solution at much more speed as compared to finite-difference methods.

Linking these two methods (LGM and GREAT) together using a special software module which is considered as part of this invention, enables the fast on-way coupled tool for modeling of reservoir geomechanics. Functionality implemented in this special software module can be presented as 3 main stages:
exporting information on the layered reservoir necessary to calculate pressure fields from LGM in the format supported by GREAT;
running GREAT using the exported input parameters;
importing the output of GREAT determining the applied pressure loading and running LGM to calculate displacements and stresses.

Thus, for determining pore pressure distribution by means of GREAT it is necessary to predetermine hydrodynamic parameters of the layers and geotechnical parameters of wells.

The hydrodynamic parameters of the layers include an initial pore pressure of a layer, permeability (k) of the layer, porosity of the layer, initial gas or oil saturation, oil viscosity, viscosity of a driving agent and a displaced fluid, initial and finite saturation of the driving agent.

The geotechnical parameters of the wells include coordinates of layer intersection of a well for each layer, bottom and top depth for each layer in the well section, well production rate, evolution of current and cumulative oil or gas production, evolution of current and cumulative driving agent injection.

Specification of the problem parameters to be calculated in GREAT can be done using either input data files in text format and keywords, or using GREAT's Application Programming Interface (API) designed as dynamic link library (dll). Data exchange using API is much faster. Data exchange by text files is more transparent for debugging and needs less modification to be compatible with future versions of GREAT.

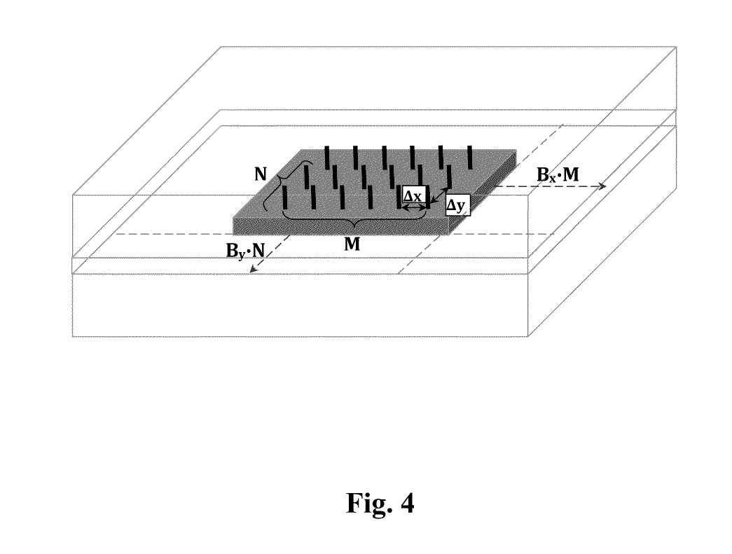

The calculation process in GREAT is based on a summation of contributions from elementary solutions for point sources and plane boundaries, and does not involve approximation on the discrete mesh covering the whole domain to effectively decrease problem dimension and gain calculation speed. Consequently, GREAT calculates pressure values in the locations of flow sources, while the mechanical solver needs to input the pressure map to calculate resulting deformations. To build the pressure distribution acting as an applied loading in the mechanical simulator it is suggested to introduce a uniform grid of inactive wells with zero flow rates and use them as pressure sensors as shown in FIG. 4.

The input data for the one-way coupled LGM+GREAT simulation is organized as a text file comprising set of sections.

Section “FILES” specifies the full path to the GREAT executable and the name of an output file.

Section “DIMENSIONS” specifies the geometry and the size of the problem in the horizontal plane. In particular, it specifies the size of the grid of sensor wells and the spacing between them and the size of the LGM grid. Porous reservoir simulated by GREAT has to be embedded inside elastic domain of bigger size, because far field mechanical boundary conditions has to be specified reasonably distant from the source of the applied loading in the reservoir. The distance from the reservoir to the lateral boundary is specified in terms of boundary margin multipliers Bₓ, B_{y} defining the ratio between this distance and the reservoir size, as shown in FIG. 4. Boundary conditions on lateral boundaries in LGM are zero displacements. The mesh step between nodes in the LGM calculations is selected to be the same as the spacing between sensor wells in GREAT. In total, there are (2Bₓ+1)·(2B_{y}+1)·M·N nodes in the LGM calculation, where M·N is the size of the grid of sensor wells.

Section “LAYERS” defines the sequence of layers starting from the surface towards increasing depth, their thicknesses and mechanical properties as shown in FIG. 2. Layers which are producing and requiring external input of a pressure field are marked with the flag “PRESSURE LOAD=1.” For these layers, there are two input options possible: 1) a text file containing a M×N table of pressure values; and 2) a reference to the GREAT input file for the layer, which is to be processed. Before executing GREAT in the second case the input file is expanded with an automatically generated grid of M×N vertical sensor wells, which are placed in the middle of the producing layer.

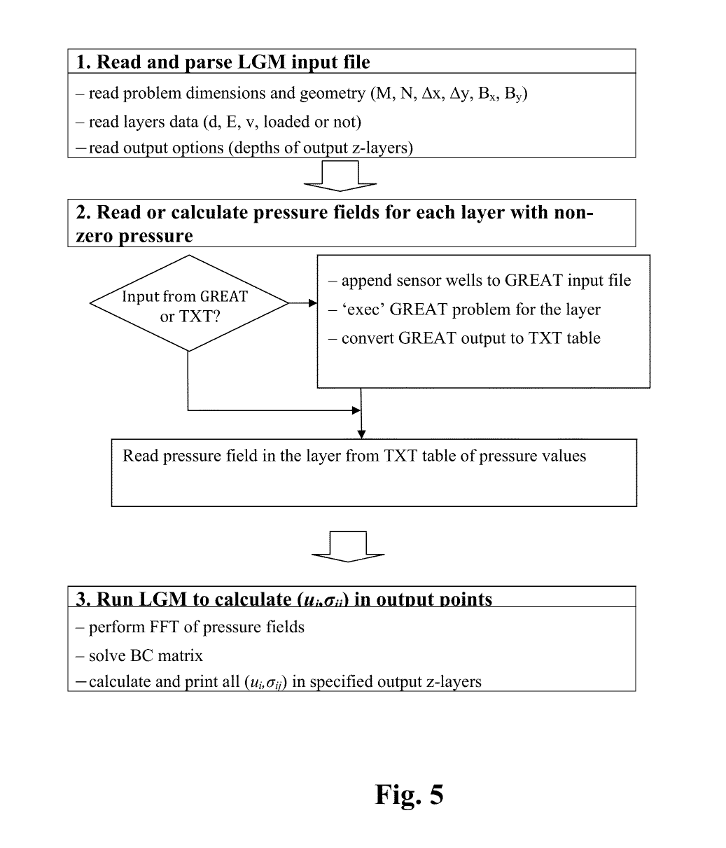

The “OUTPUT” section defines the list of output layers in the z direction in which it is required to calculate output data. The main steps of the algorithm are given in FIG. 5

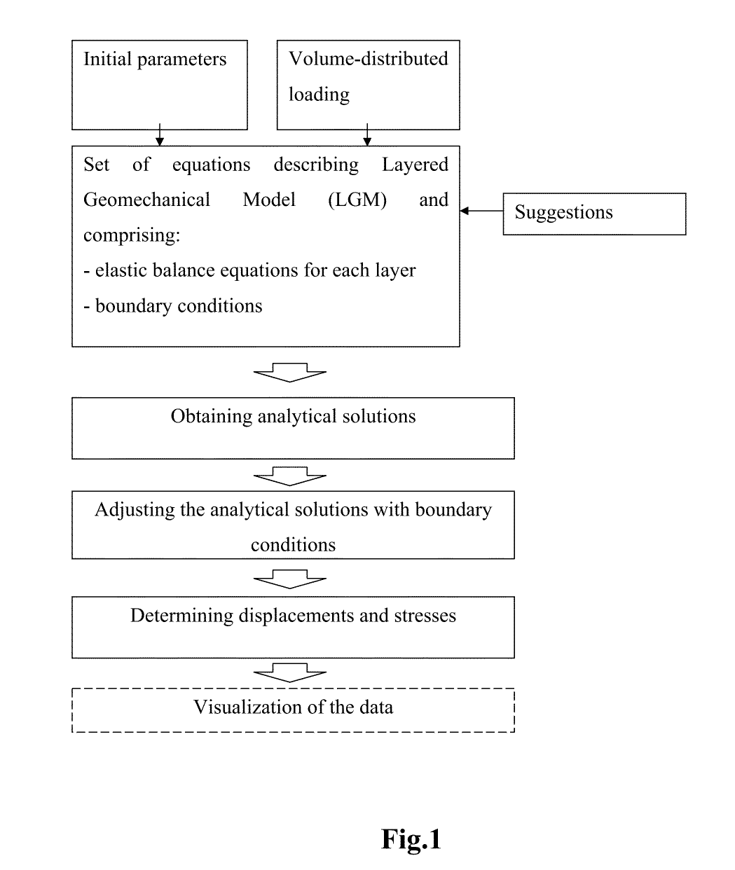

Analysis of the results obtained after performing of a single LGM+GREAT simulation (FIG. 1) usually includes verification of the result, which may be based on comparison against other reference case solution either in the whole or in the part of the definition domain or may be limited just to checking if the solution falls within reasonable interval. If the solution is not satisfactory, then the intended workflow returns to the step 1 shown on FIG. 1 to modify input parameters controlling the numerical model and simulation shown on FIG. 1 is repeated. Same cycling of multiple simulation runs is also necessary in case of a history matching problem. In this case resulting solution is compared against targets selected by the user for some of the output physical quantities and the variation of the input parameters is continued until the selected targets are matched within certain tolerance. Performing of multiple runs of the LGM-GREAT numerical simulation is also necessary when doing parametric study to determine how variation of input parameters influences the final solution.

An equation for a separate poroelastic layer characterizing an elastic stress balance is as follows:

(λ+2μ)\vec{∇}·(\vec{∇}·u)−μ·\vec{∇}×\vec{∇}×u+f=0, (1)

where ∇ is a differential operator, u—a displacement vector of a geologic medium in selected points of a layer, λ, μ—Lame's elastic parameters, f—a volume-distributed loading.

Equation (1) is written in invariant form. It will be solved in Cartesian coordinates, with the z axis directed perpendicular to the layers. The solution is constructed under the following assumptions: the only loading present is due to the pore pressure gradient f=α\vec{∇}p(\vec{r}), where α is Biot's poroelastic constant; pressure can be decomposed into a z function and a (x, y) function; and pressure variation in the z direction is described by a 3^{rd} order polynomial. Equation (1) can be transformed into the following:

$${∇}^{2} u ( x , y , z ) + β \vec{∇} ( \vec{∇} u ( x , y , z ) ) - \vec{∇} ( h ( x , y ) p ( z ) ) = 0 , \\ β = \frac{λ + μ}{μ} , \\ p ( z ) = 1 + {p}_{1} z + {p}_{2} {z}^{2} + {p}_{3} {z}^{3} , \\ h ( x , y ) p ( z ) = \frac{α}{μ} p ( \vec{r} ) , \qquad ( 2 )$$

where new descriptions for nondimensional factor β, for pressure variation for z direction p(z), and (x, y) pressure variation h(x, y) are introduced. For solution of three combined second-order equations (2) in 3D, potential function method is used with subsequent integral conversion, for example, see V. M. Entov, T. A. Malahova, About rock formation stress change when fluid-filled stratum pressure changes, RAN news, Mechanics of rigid body No 6, pp. 53-65, 1974; and also I. N. Sneddon, Fourier Transforms, Dover, N.Y., 1995, where it was used to formulate an axisymmetric solution.

The ansatz of the solution using the potential function Φ and non-divergent vector field Ψ is:

$$\begin{matrix}{u}_{x} = - β {\partial }_{x} {\partial }_{z} Φ + {Ψ}_{x} , & ( 3 ) \\ {u}_{y} = - β {\partial }_{y} {\partial }_{z} Φ + {Ψ}_{y} , & ( 4 ) \\ {u}_{z} = ( β + 1 ) {∇}^{2} Φ - β {\partial }_{z}^{2} Φ + h \cdot η , \\ where & ( 5 ) \\ η ( z ) = z + \frac{{p}_{1}}{2} {z}^{2} + \frac{{p}_{2}}{3} {z}^{3} + \frac{{p}_{3}}{4} {z}^{4} , \\ {η}^{′} = p & ( 6 ) \\ {\partial }_{x} {Ψ}_{x} + {\partial }_{y} {Ψ}_{y} = 0. & ( 7 )\end{matrix}$$

After substitution of (3-5) into (2), one can obtain the equivalent set of equations:

$$\begin{matrix}{∇}^{4} Φ + \frac{1}{β + 1} {∇}^{2} ( h \cdot η ) = 0 , & ( 8 ) \\ {∇}^{2} {Ψ}_{x} = {∇}^{2} {Ψ}_{y} = 0. & ( 9 )\end{matrix}$$

Introduction of the non-divergent vector field Ψ in the selected form (3-4) helps to divide the original equation (2) into a set of independent equations (8-9).

Solution of (8-9) is sought using a 2D integral Fourier transform in the (x, y) plane:

Φ(x,y,z)=∫∫G(m,n,z)φ(mx)φ(ny)dmdn, (10)

Ψ_{x,y}(x,y,z)=∫∫ Ψ̅_{x,y}(m,n,z)φ(mx)φ(ny)dmdn, (11)

with basis functions

∂ₓφ(mx)=imφ(mx), ∂ₓ²φ(mx)=−m²φ(mx), φ(mx)=exp(imx). (1)

After substitution of (10-11) into (8-9) we obtain

$$\begin{matrix}\int \int [ {( {\partial }_{z}^{2} - {k}^{2} )}^{2} G - \frac{1}{β + 1} ( {\partial }_{z} p - {k}^{2} η ) \overline{h} ] φ ( k \cdot r ) d k = 0 , & ( 13 ) \\ \int \int ( {\partial }_{z}^{2} - {k}^{2} ) {\overline{Ψ}}_{x , y} φ ( k \cdot r ) d k = 0 , & ( 14 )\end{matrix}$$

where wave vector k and image of source function h̅(m,n) are defined as

k=(m,n), k=\sqrt{m²+n²}, (15)

h(x,y)=∫∫ h̅(m,n)φ(mx)φ(ny)dmdn. (16)

The solution of the ordinary differential equations under the integrals (13-14) yields the general form of kernel functions:

$$\begin{matrix}G ( m , n , z ) = ( {A}_{1} ( k ) + {A}_{2} ( k ) \cdot z ) {e}^{kz} + ( {A}_{3} ( k ) + {A}_{4} ( k ) \cdot z ) {e}^{- kz} ++ \frac{1}{β + 1} \frac{\overline{h} ( m , n )}{{k}^{2}} ( \frac{{p}_{3}}{4} {z}^{4} + \frac{{p}_{2}}{3} {z}^{3} + \frac{6 {p}_{3} + {k}^{2} {p}_{1}}{2 {k}^{2}} {z}^{2} + \frac{2 {p}_{2} + {k}^{2}}{{k}^{2}} z + \frac{6 {p}_{3} + {k}^{2} {p}_{1}}{{k}^{4}} ) , & ( 17 ) \\ {\overline{Ψ}}_{x} ( m , n , z ) = i n ( {A}_{5} ( k ) {e}^{kz} + {A}_{6} ( k ) {e}^{- kz} ) , & ( 18 ) \\ {\overline{Ψ}}_{y} ( m , n , z ) = - im ( {A}_{5} ( k ) {e}^{kz} + {A}_{6} ( k ) {e}^{- kz} ) . & ( {18}^{′} )\end{matrix}$$

To find actual values of displacements, it is necessary to introduce 6 boundary conditions that would fix free parameters A₁-A₆ and perform differentiation in (3-5), and apply the forward Fourier transform in (10-11). Stresses can be found from derivatives of displacements and deformations using Hooke's law.

To construct the full solution for the 3D layered configuration, it is necessary to link individual solutions in each layer by proper selection and solution of contact boundary conditions on the interface planes between layers. In 3D it is necessary to have 6 conditions between each set of neighboring layers, and 3 conditions on the top and bottom external boundaries. At the bottom all displacement components are zero as z→∞. On the free surface at the top tractions are zero:

$${σ}_{zz}^{1} ( x , y , - \frac{{d}_{1}}{2} ) = {σ}_{xz}^{1} ( x , y , - \frac{{d}_{1}}{2} ) = {σ}_{yz}^{1} ( x , y , - \frac{{d}_{1}}{2} ) = 0. \qquad ( 19 )$$

It is accepted that a local coordinate system inside each poroelastic layer is centered, z=0 is located in the middle of the layer; points (x=0; y=0) are aligned along the same vertical line. The top index of σ and u refers to the layer number; numeration of layers i=1 . . . n is done from top to bottom as in FIG. 2. The internal boundaries represent perfect elastic contacts between layers with perfect impermeable barriers to fluid flow between. There is thus no stress discontinuity on the interfaces:

$${σ}_{zz}^{i} ( x , y , \frac{{d}_{i}}{2} ) + {p}_{i} ( x , y , \frac{{d}_{i}}{2} ) = {σ}_{zz}^{i + 1} ( x , y , - \frac{{d}_{i + 1}}{2} ) + {p}_{i + 1} ( x , y , - \frac{{d}_{i + 1}}{2} ) , \\ {σ}_{xz}^{i} ( x , y , \frac{{d}_{i}}{2} ) = {σ}_{xz}^{i + 1} ( x , y , - \frac{{d}_{i + 1}}{2} ) , \\ {σ}_{yz}^{i} ( x , y , \frac{{d}_{i}}{2} ) = {σ}_{yz}^{i + 1} ( x , y , - \frac{{d}_{i + 1}}{2} ) . \qquad ( 20 )$$

There can only be displacement discontinuity in the tangential direction, which is completely determined by the shear stress on the interface:

$${u}_{x}^{i} ( x , y , \frac{{d}_{i}}{2} ) - {u}_{x}^{i + 1} ( x , y , - \frac{{d}_{i + 1}}{2} ) = {C}_{i} {σ}_{xz}^{i} ( x , y , \frac{{d}_{i}}{2} ) , \\ {u}_{y}^{i} ( x , y , \frac{{d}_{i}}{2} ) - {u}_{y}^{i + 1} ( x , y , - \frac{{d}_{i + 1}}{2} ) = {C}_{i} {σ}_{yz}^{i} ( x , y , \frac{{d}_{i}}{2} ) , \\ {u}_{z}^{i} ( x , y , \frac{{d}_{i}}{2} ) = {u}_{z}^{i + 1} ( x , y , - \frac{{d}_{i + 1}}{2} ) , \qquad ( 21 )$$

where Cᵢ is the tangential compliance of the inter-layer bond, isotropic inside the (x, y) plane.

Boundary conditions (20, 21) are to be satisfied at any point (x, y). It can be shown that this is equivalent to the condition that (20, 21) must hold for the Fourier images of physical components at any point (m, n). After substitutions of (10, 11, 18) into (3-5), and applying σᵢⱼ=λεₖₖδᵢⱼ+2μεᵢⱼ to determine stress components:

$${\overline{u}}_{x} = - im β {\partial }_{z} G ( k , z ) + i n ( {A}_{5} ( k ) {e}^{kz} + {A}_{6} ( k ) {e}^{- kz} ) \\ {\overline{u}}_{y} = - i n β {\partial }_{z} G ( k , z ) + i m ( {A}_{5} ( k ) {e}^{kz} + {A}_{6} ( k ) {e}^{- kz} ) \\ {\overline{u}}_{z} = {\partial }_{z}^{2} G ( k , z ) - ( β + 1 ) {k}^{2} G ( k , z ) + \overline{h} ( m , n ) η ( z ) \\ \begin{matrix}\frac{{\overline{σ}}_{xx}}{μ} = ( β - 1 ) ( {\partial }_{x} {\overline{u}}_{x} + {\partial }_{y} {\overline{u}}_{y} + {\partial }_{z} {\overline{u}}_{z} ) + 2 {\partial }_{x} {\overline{u}}_{x} = \\ = β ( β - 1 ) ( {k}^{2} + 2 {m}^{2} ) {\partial }_{z} G ( k , z ) + \\ ( β - 1 ) ( ( {\partial }_{z}^{2} - ( β + 1 ) {k}^{2} ) G ( k , z ) + \overline{h} ( m , n ) η ( z ) ) - \\ 2 mn ( {A}_{5} ( k ) {e}^{kz} + {A}_{6} ( k ) {e}^{- kz} )\end{matrix} \\ \begin{matrix}\frac{{\overline{σ}}_{yy}}{μ} = ( β - 1 ) ( {\partial }_{x} {\overline{u}}_{x} + {\partial }_{y} {\overline{u}}_{y} + {\partial }_{z} {\overline{u}}_{z} ) + 2 {\partial }_{y} {\overline{u}}_{y} = \\ = β ( β - 1 ) ( {k}^{2} + 2 {m}^{2} ) {\partial }_{z} G ( k , z ) + \\ ( β - 1 ) ( ( {\partial }_{z}^{2} - ( β + 1 ) {k}^{2} ) G ( k , z ) + \overline{h} ( m , n ) η ( z ) ) + \\ 2 mn ( {A}_{5} ( k ) {e}^{kz} + {A}_{6} ( k ) {e}^{- kz} )\end{matrix} \\ \begin{matrix}\frac{{\overline{σ}}_{zz}}{μ} = ( β - 1 ) ( {\partial }_{x} {\overline{u}}_{x} + {\partial }_{y} {\overline{u}}_{y} + {\partial }_{z} {\overline{u}}_{z} ) + 2 {\partial }_{z} {\overline{u}}_{z} = \\ = β ( β - 1 ) {k}^{2} {\partial }_{z} G ( k , z ) + \\ ( β + 1 ) ( ( {\partial }_{z}^{2} - ( β + 1 ) {k}^{2} ) G ( k , z ) + \overline{h} ( m , n ) η ( z ) )\end{matrix} \\ \begin{matrix}\frac{{\overline{σ}}_{xz}}{μ} = \frac{{\overline{σ}}_{zx}}{μ} \\ = ( {\partial }_{x} {\overline{u}}_{z} + {\partial }_{z} {\overline{u}}_{x} ) \\ = im ( - ( ( β - 1 ) {\partial }_{z}^{2} + ( β + 1 ) {k}^{2} ) G ( k , z ) + \overline{h} ( m , n ) η ( z ) ) + \\ ikn ( {A}_{5} ( k ) {e}^{kz} - {A}_{6} ( k ) {e}^{- kz} )\end{matrix} \\ \begin{matrix}\frac{{\overline{σ}}_{yz}}{μ} = \frac{{\overline{σ}}_{zy}}{μ} \\ = ( {\partial }_{y} {\overline{u}}_{z} + {\partial }_{z} {\overline{u}}_{y} ) \\ = i n ( - ( ( β - 1 ) {\partial }_{z}^{2} + ( β + 1 ) {k}^{2} ) G ( k , z ) + \overline{h} ( m , n ) η ( z ) ) - \\ ikm ( {A}_{5} ( k ) {e}^{kz} - {A}_{6} ( k ) {e}^{- kz} )\end{matrix} \\ \begin{matrix}\frac{{\overline{σ}}_{xy}}{μ} = \frac{{\overline{σ}}_{yx}}{μ} \\ = ( {\partial }_{x} {\overline{u}}_{y} + {\partial }_{y} {\overline{u}}_{x} ) \\ = 2 mn β {\partial }_{z} G ( k , z ) + ( {n}^{2} - {m}^{2} ) ( {A}_{5} ( k ) {e}^{kz} + {A}_{6} ( k ) {e}^{- kz} )\end{matrix} \qquad ( 22 )$$

Substituting the expression for kernel-function G (17) and grouping members around A₁-A₆ factors:

$${\overline{u}}_{x} = - i m β ( \begin{matrix}( {kA}_{1} + ( 1 + kz ) {A}_{2} ) {e}^{kz} - \\ ( {kA}_{3} - ( 1 - kz ) {A}_{4} ) {e}^{- kz} + \frac{\overline{h} ( m , n )}{β ( 1 + β )} ξ ( k , z )\end{matrix} ) + i n ( {A}_{5} {e}^{kz} + {A}_{6} {e}^{- kz} ) , \\ {\overline{u}}_{y} = - i n β ( \begin{matrix}( {kA}_{1} + ( 1 + kz ) {A}_{2} ) {e}^{kz} - \\ ( {kA}_{3} - ( 1 - kz ) {A}_{4} ) {e}^{- kz} + \frac{\overline{h} ( m , n )}{β ( 1 + β )} ξ ( k , z )\end{matrix} ) + im ( {A}_{5} {e}^{kz} + {A}_{6} {e}^{- kz} ) , \\ {\overline{u}}_{z} = β k ( ( - {kA}_{1} + ( \frac{2}{β} - kz ) {A}_{2} ) {e}^{kz} - ( {kA}_{3} + ( \frac{2}{β} + kz ) {A}_{4} ) {e}^{- kz} ) - \frac{β \cdot \overline{h} ( m , n )}{{k}^{2} ( 1 + β )} γ ( k , z ) , \\ \frac{{\overline{σ}}_{xx}}{μ} = 2 {m}^{2} β ( ( {kA}_{1} + ( ( \frac{β - 1}{β} \frac{{k}^{2}}{{m}^{2}} + 1 ) + kz ) {A}_{2} ) {e}^{kz} - ( {kA}_{3} + ( - ( \frac{β - 1}{β} \frac{{k}^{2}}{{m}^{2}} + 1 ) + kz ) {A}_{4} ) {e}^{- kz} ) ++ \frac{β \cdot \overline{h} ( m , n )}{β + 1} χ ( m , k , z ) - 2 mn ( {A}_{5} {e}^{kz} + {A}_{6} {e}^{- kz} ) , \\ \frac{{\overline{σ}}_{yy}}{μ} = 2 {n}^{2} β ( ( {kA}_{1} + ( ( \frac{β - 1}{β} \frac{{k}^{2}}{{n}^{2}} + 1 ) + kz ) {A}_{2} ) {e}^{kz} - ( {kA}_{3} + ( - ( \frac{β - 1}{β} \frac{{k}^{2}}{{n}^{2}} + 1 ) + kz ) {A}_{4} ) {e}^{- kz} ) ++ \frac{β \cdot \overline{h} ( m , n )}{β + 1} χ ( n , k , z ) - 2 mn ( {A}_{5} {e}^{kz} + {A}_{6} {e}^{- kz} ) , \\ \frac{{\overline{σ}}_{zz}}{μ} = 2 β {k}^{2} ( ( - {kA}_{1} + ( \frac{1}{β} - kz ) {A}_{2} ) {e}^{kz} + ( {kA}_{3} + ( \frac{1}{β} + kz ) {A}_{4} ) {e}^{- kz} ) + \frac{β ( β - 1 ) \cdot \overline{h} ( m , n )}{( 1 + β )} {γ}_{2} ( k , z ) , \\ \frac{{\overline{σ}}_{xz}}{μ} = - i β mk ( \begin{matrix}- ( {kA}_{1} + ( \frac{β - 1}{β} + kz ) {A}_{2} ) {e}^{kz} - \\ ( {kA}_{3} - ( \frac{β - 1}{β} - kz ) {A}_{4} ) {e}^{- kz} - \frac{\overline{h} ( m , n )}{{k}^{2} ( 1 + β )} γ ( k , z )\end{matrix} ) + ikn ( {A}_{5} {e}^{kz} - {A}_{6} {e}^{- kz} ) , \\ \frac{{\overline{σ}}_{yz}}{μ} = - i β nk ( \begin{matrix}- ( {kA}_{1} + ( \frac{β - 1}{β} + kz ) {A}_{2} ) {e}^{kz} - \\ ( {kA}_{3} - ( \frac{β - 1}{β} - kz ) {A}_{4} ) {e}^{- kz} - \frac{\overline{h} ( m , n )}{{k}^{2} ( 1 + β )} γ ( k , z )\end{matrix} ) - ikm ( {A}_{5} {e}^{kz} - {A}_{6} {e}^{- kz} ) \\ \frac{{\overline{σ}}_{xy}}{μ} = 2 mn β ( ( {kA}_{1} + ( 1 + kz ) {A}_{2} ) {e}^{kz} - ( {kA}_{3} - ( 1 - kz ) {A}_{4} ) {e}^{- kz} ) + 2 mn \frac{β \cdot \overline{h} ( m , n )}{{k}^{2} ( 1 + β )} ξ ( k , z ) + ( {n}^{2} - {m}^{2} ) ( {A}_{5} {e}^{kz} + {A}_{6} {e}^{- kz} ) , \qquad ( 23 )$$

where the new notations for the functions near the source term h̅(m,n) are introduced, which account for the spline variation of pressure function in the z-direction:

$$γ ( k , z ) = 3 {p}_{3} {z}^{2} + 2 {p}_{2} z + ( {p}_{1} + \frac{6 {p}_{3}}{{k}^{2}} ) , \\ {γ}_{2} ( k , z ) = {p}_{3} {z}^{3} + {p}_{2} {z}^{2} + ( {p}_{1} - \frac{12}{( β - 1 ) {k}^{2}} {p}_{3} ) z + ( 1 - \frac{4}{( β - 1 ) {k}^{2}} {p}_{2} ) , \\ ξ ( k , z ) = {p}_{3} {z}^{3} + {p}_{2} {z}^{2} + ( {p}_{1} + \frac{6 {p}_{3}}{{k}^{2}} ) z + ( 1 + \frac{2 {p}_{2}}{{k}^{2}} ) , \\ χ ( m , k , z ) = ( β - 1 + 2 \frac{{m}^{2}}{{k}^{2}} ) ( \begin{matrix}{p}_{3} {z}^{3} + {p}_{2} {z}^{2} + ( {p}_{1} + \frac{12 {p}_{3}}{{k}^{2} ( ( β - 1 ) \frac{{k}^{2}}{{m}^{2}} + 2 )} ) z + \\ ( 1 + \frac{4 {p}_{2}}{{k}^{2} ( ( β - 1 ) \frac{{k}^{2}}{{m}^{2}} + 2 )} )\end{matrix} ) . \qquad ( 24 )$$

In the final form of boundary conditions (20, 21) derived to calculate coefficients A₁-A₆, the equivalent linear replacement is used:

ū_{rz}=imūₓ+inū_{y}, ū_{φc}=imūₓ−inū_{y}, (25)

σ̅_{rz}=im σ̅_{xz}+in σ̅_{yz}, σ̅_{φc}=im σ̅_{xz}−in σ̅_{yz}. (26)

Using these expressions contact boundary conditions (20-21) are transformed into:

$$\begin{matrix}\begin{matrix}{\overline{u}}_{z}^{i} - {\overline{u}}_{z}^{i + 1} = 0 \text{:} {β}^{i} k ( \begin{matrix}( - {kA}_{1}^{i} + ( \frac{2}{{β}^{i}} - {kd}_{i} ) {A}_{2}^{i} ) {e}^{{kd}_{i}} - \\ ( {kA}_{3}^{i} + ( \frac{2}{{β}^{i}} + {kd}_{i} ) {A}_{4}^{i} ) {e}^{- {kd}_{i}}\end{matrix} ) -- \\ {β}^{i + 1} k ( \begin{matrix}( - {kA}_{1}^{i + 1} + ( \frac{2}{{β}^{i + 1}} + {kd}_{i + 1} ) {A}_{2}^{i + 1} ) {e}^{- {kd}_{i + 1}} - \\ ( {kA}_{3}^{i + 1} + ( \frac{2}{{β}^{i + 1}} - {kd}_{i + 1} ) {A}_{4}^{i + 1} ) {e}^{{kd}_{i + 1}}\end{matrix} ) = \\ = \frac{{β}^{i} \cdot {\overline{h}}^{i} ( m , n )}{{k}^{2} ( {β}^{i} + 1 )} {γ}^{i} ( k , {d}_{i} ) - \frac{{β}^{i + 1} \cdot {\overline{h}}^{i + 1} ( m , n )}{{k}^{2} ( {β}^{i + 1} + 1 )} {γ}^{i + 1} ( k , - {d}_{i + 1} ) ,\end{matrix} & ( 27 ) \\ \begin{matrix}{\overline{σ}}_{zz}^{i} - {\overline{σ}}_{zz}^{i + 1} = 0 \text{:} {β}^{i} k ( \begin{matrix}( - {kA}_{1}^{i} + ( \frac{1}{{β}^{i}} - {kd}_{i} ) {A}_{2}^{i} ) {e}^{{kd}_{i}} + \\ ( {kA}_{3}^{i} + ( \frac{1}{{β}^{i}} + {kd}_{i} ) {A}_{4}^{i} ) {e}^{- {kd}_{i}}\end{matrix} ) -- \\ {β}^{i + 1} k ( \begin{matrix}( - {kA}_{1}^{i + 1} + ( \frac{1}{{β}^{i + 1}} + {kd}_{i + 1} ) {A}_{2}^{i + 1} ) {e}^{- {kd}_{i + 1}} + \\ ( {kA}_{3}^{i + 1} + ( \frac{1}{{β}^{i + 1}} - {kd}_{i + 1} ) {A}_{4}^{i + 1} ) {e}^{{kd}_{i + 1}}\end{matrix} ) = \\ = \frac{{β}^{i} ( {β}^{i} - 1 ) \cdot {\overline{h}}^{i} ( m , n )}{2 {k}^{2} ( {β}^{i} + 1 )} {γ}_{2}^{i} ( k , {d}_{i} ) - \\ \frac{{β}^{i + 1} ( {β}^{i + 1} - 1 ) \cdot {\overline{h}}^{i + 1} ( m , n )}{2 {k}^{2} ( {β}^{i + 1} + 1 )} {γ}_{2}^{i + 1} ( k , - {d}_{i + 1} ) ,\end{matrix} & ( 28 ) \\ \begin{matrix}{\overline{σ}}_{rz}^{i} - {\overline{σ}}_{rz}^{i + 1} = 0 \text{:} {β}^{i} k ( \begin{matrix}( - {kA}_{1}^{i} - ( \frac{{β}^{i} - 1}{{β}^{i}} + {kd}_{i} ) {A}_{2}^{i} ) {e}^{{kd}_{i}} - \\ ( {kA}_{3}^{i} - ( \frac{{β}^{i} - 1}{{β}^{i}} - {kd}_{i} ) {A}_{4}^{i} ) {e}^{- {kd}_{i}}\end{matrix} ) -- \\ {β}^{i + 1} k ( \begin{matrix}( - {kA}_{1}^{i + 1} - ( \frac{{β}^{i + 1} - 1}{{β}^{i + 1}} - {kd}_{i + 1} ) {A}_{2}^{i + 1} ) {e}^{- {kd}_{i + 1}} - \\ ( {kA}_{3}^{i + 1} - ( \frac{{β}^{i + 1} - 1}{{β}^{i + 1}} + {kd}_{i + 1} ) {A}_{4}^{i + 1} ) {e}^{{kd}_{i + 1}}\end{matrix} ) = \\ = \frac{{β}^{i} \cdot {\overline{h}}^{i} ( m , n )}{{k}^{2} ( {β}^{i} + 1 )} {γ}^{i} ( k , {d}_{i} ) - \frac{{β}^{i + 1} \cdot {\overline{h}}^{i + 1} ( m , n )}{{k}^{2} ( {β}^{i + 1} + 1 )} {γ}^{i + 1} ( k , - {d}_{i + 1} ) ,\end{matrix} & ( 29 ) \\ \begin{matrix}{\overline{u}}_{rz}^{i} - {\overline{u}}_{rz}^{i + 1} = C {\overline{σ}}_{rz}^{i} \text{:} - {β}^{i} ( \begin{matrix}( {kA}_{1}^{i} + ( 1 + {kd}_{i} ) {A}_{2}^{i} ) {e}^{{kd}_{i}} - \\ ( {kA}_{3}^{i} - ( 1 - {kd}_{i} ) {A}_{4}^{i} ) {e}^{- {kd}_{i}}\end{matrix} ) - \\ \frac{{β}^{i} \cdot {\overline{h}}^{i} ( m , n )}{{k}^{2} ( {β}^{i} + 1 )} {ξ}^{i} ( k , {d}_{i} ) ++ \\ {β}^{i + 1} ( \begin{matrix}( {kA}_{1}^{i + 1} + ( 1 - {kd}_{i + 1} ) {A}_{2}^{i + 1} ) {e}^{- {kd}_{i + 1}} - \\ ( {kA}_{3}^{i + 1} - ( 1 + {kd}_{i + 1} ) {A}_{4}^{i + 1} ) {e}^{{kd}_{i + 1}}\end{matrix} ) + \\ \frac{{β}^{i + 1} \cdot {\overline{h}}^{i + 1} ( m , n )}{{k}^{2} ( {β}^{i + 1} + 1 )} {ξ}^{i + 1} ( k , - {d}_{i + 1} ) = \\ = \frac{2 C μ}{k} {β}^{i + 1} ( \begin{matrix}- ( \begin{matrix}{kA}_{1}^{i + 1} + \\ ( \frac{{β}^{i + 1} - 1}{{β}^{i + 1}} - {kd}_{i + 1} ) {A}_{2}^{i + 1}\end{matrix} ) {e}^{- {kd}_{i + 1}} - \\ ( \begin{matrix}{kA}_{3}^{i + 1} - \\ ( \frac{{β}^{i + 1} - 1}{{β}^{i + 1}} + {kd}_{i + 1} ) {A}_{4}^{i + 1}\end{matrix} ) {e}^{{kd}_{i + 1}}\end{matrix} ) - \\ \frac{2 C μ}{k} {β}^{i + 1} ( \frac{{\overline{h}}^{i + 1} ( m , n )}{{k}^{3} ( {β}^{i + 1} + 1 )} {γ}^{i + 1} ( k , - {d}_{i + 1} ) ) ,\end{matrix} & ( 30 ) \\ \begin{matrix}{\overline{u}}_{ϕ z}^{i} - {\overline{u}}_{ϕ z}^{i + 1} = 0 \text{:} {A}_{5}^{i} {e}^{{kd}_{i}} - {A}_{6}^{i} {e}^{- {kd}_{i}} - ( {A}_{5}^{i + 1} {e}^{- {kd}_{i + 1}} - {A}_{6}^{i} {e}^{{kd}_{i + 1}} ) \\ = 0 ,\end{matrix} & ( 31 ) \\ \begin{matrix}{\overline{u}}_{ϕ z}^{i} - {\overline{u}}_{ϕ z}^{i + 1} = C {\overline{σ}}_{ϕ z}^{i} \text{:} ( {A}_{5}^{i} {e}^{{kd}_{i}} + {A}_{6}^{i} {e}^{- {kd}_{i}} ) - ( {A}_{5}^{i + 1} {e}^{- {kd}_{i + 1}} + {A}_{6}^{i} {e}^{{kd}_{i + 1}} ) \\ = C μ k ( {A}_{5}^{i + 1} {e}^{- {kd}_{i + 1}} - {A}_{6}^{i + 1} {e}^{{kd}_{i + 1}} ) .\end{matrix} & ( 32 )\end{matrix}$$

It is to be noted for the sake of brevity, dᵢ in (27-32) denotes the half-thickness of the layer i compared to the thickness of layers represented in FIG. 2. Equations (27-32) specify boundary conditions on the internal interfaces between layers at i=1 . . . n−1. To specify the traction-free conditions (19) on the surface one can take equations (28, 29, 31) at i=0 and then, substitute A₁⁰ . . . A₅⁰=0 to retain only terms from the first top layer. The bottom layer i=n has infinite thickness dᵢ=∞. In the last layer it is convenient to select coordinate z=0 on the top of the layer, not in the middle of the layer as in the finite-thickness layers. Then, the system (27-32) will also hold for the last contact interface at i=n, after substitution of dₙ=0 and A₁ⁿ=A₂ⁿ=A₅ⁿ=0, which follows from the zero boundary condition at infinity.

After proper treatment of boundary conditions on the first and last inter-layer interfaces, one obtains a banded 4-diagonal matrix of size 6*(n−1)+3, which is complete to calculate coefficients A₁-A₆ inside all layers for any Fourier index (m, n). The subsystem of equations containing A₅-A₆ is completely independent from subsystem A₁-A₄. Because the first subsystem A₅-A₆ always has zero external loading on the right-hand side of the system of equations, its solution is trivial: A₅=A₆=0. The system matrix is thus reduced to 4*(n−1)+2 equations (27-30), which can be solved using any matrix-inversion algorithm.

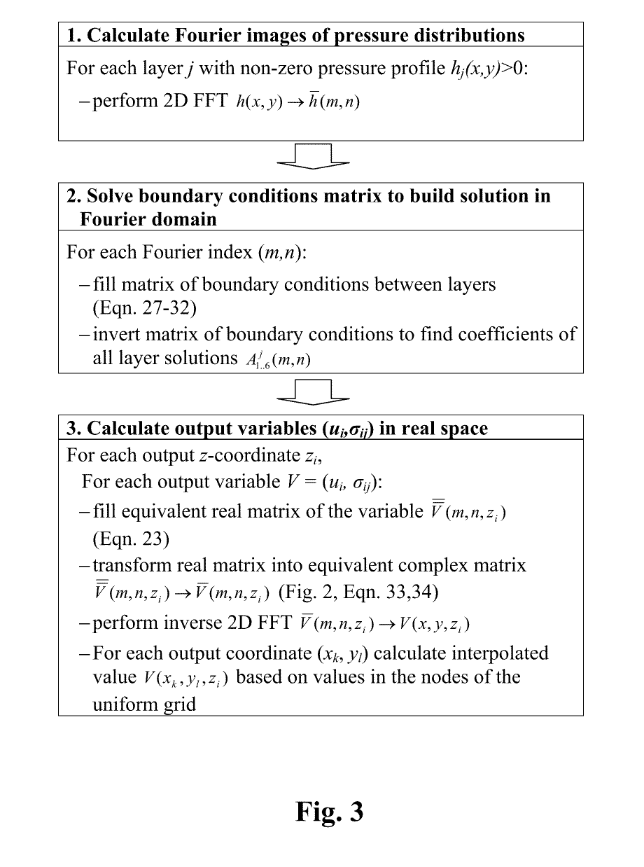

Schematically (FIG. 3), calculation of displacement and stress components at given points (x, y, z)ⱼ requires the following steps: 1) performing forward integral transform of the loading profiles inside layers with the applied loading; 2) inverting boundary conditions matrix to build the solution in the transformed domain; 3) performing inverse integral transform of the solution at specified points in the layers which contain output points (x, y, z)ⱼ.

In actual numerical calculations, it is more impractical to replace continual integration of transforms (10, 11, 16) by a Fast Fourier Transform, which is equivalent to Euler numerical integration in the rectangular domain. This introduces a regular grid of M×N approximation nodes and the rectangular domain, with dimensions Δx·M by Δy·N, where spatial steps are selected by a user according to the desired approximation accuracy.

Fourier transform is the most costly part of the algorithm, because it requires O(MN·log MN) operations for each layer with non-zero pressure distribution and for each output variable (uᵢ, σᵢⱼ) and each unique z coordinate where output data is calculated. Solution of the boundary conditions matrix requires only O(L MN), where L is number of layers.

It is quite important to use as efficient and robust FFT algorithm as possible. One of the options is to apply well-established multiplatforms such as FFTW Library, www.fftw.org; CUDA CUFFT Library, NVIDIA Corp., 2008, http://www.nvidia.com/object/cuda_develop.html. It is also possible to use any others existing or workable FFT libraries that best fit purposes of a user.

As an example of the offered method, let's consider measuring of displacements and stress caused by development of fields with flooding by classical five-pointed plan. Let us consider a singular five-pointed pattern consisting of four production wells and one injection well.

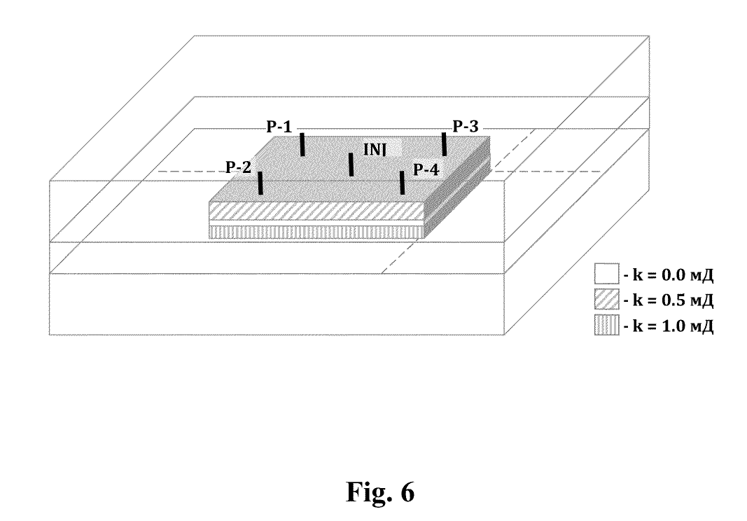

Let us define initial parameters of considered 3D task of development geomechanical modeling by five-pointed plan. The initial parameters are chosen randomly within the frames of possible rocks properties and typical characteristics of oil & gas fields. The task geometry is illustrated on FIG. 6. Graphic visualization on figure is performed using Schlumberger software products not relating to this application. Different types of hatching correspond to different values of rock formation permeability (k) changing from 0 to 1 mD. A rectangular collector with 20% porosity consists of 2 layers being developed and having permeability respectively 0.5 mD (upper) and 1 mD (lower). An impermeable barrier is located between the permeable layers. The rectangular collector has dimensions 10000 by 10000 feet. It is surrounded by impermeable elastic layers which are necessary for correct boundary conditions setting at large distance from loaded central part of task. In this case, zero tractions are set on the top free surface, zero normal displacements and slipping relative to tangential displacements are set on lateral and bottom boundaries. Both layers are crossed by four production wells marked as P-1-P-4 and one injection well marked “INJ”.

Geologic parameters of the layers and their permeability and Biot's parameters are shown in Table 1. Elastic properties of the layers are specified in terms of Young's modulus E and Poisson's ratio v, which are linked by algebraic ratio with Lame's parameters λ, μ. The full set of input parameters is duplicated in an example of input file for LGM calculation and in an example of input file for GREAT presented below.

TABLE 1

| | d, feet | E, GPa | ν | α | K, mD |
|---|---|---|---|---|---|
| 1. overlying layers | 6800 | 10 | 0.25 | 0 | 0 |
| 2. top collector | 266.7 | 2 | 0.35 | 1 | 0.5 |
| 3. barrier | 33.3 | 2 | 0.35 | 0 | 0 |
| 4. bottom collector | 400 | 2 | 0.35 | 1 | 1.0 |
| 5. supporting medium | ∞ | 10 | 0.25 | 0 | 0 |

An external load applied to the layered geologic medium during its development in the example considered is determined by means of pressure calculation with GREAT software complex. There is a constant fluid flow in the wells, 800 barrels/day in the production wells and 1600 barrels/day in the injection well. Modelling of the development is performed during a period of 1440 days, displacement and stress changes are calculated upon completion of this period. Pressure distribution calculation in two-layered collector is performed by means of two independent GREAT launches separately for each layer.

Flows through intervals of the wells crossing the layers are distributed proportionally to permeability and thickness of the layers as ¼ for the top layer and ¾ for the bottom layer. Pressure distribution is calculated on a uniform grid of 50×50 fictitious wells with a zero flow in a central part of the task. Then the calculated pressure field is converted into a format that can be downloaded to LGM and is used as a mechanical load applied to the layers. The full set of input parameters is duplicated in an example of input file for GREAT (see below).

Then, the specified initial parameters and load distribution are substituted into a set of equations composed of elastic balance equations and boundary conditions. Analytic solutions for each layer are obtained in Fourier-space and written as integral transformations. Therefore fast Fourier transform is performed to calculate solutions for separate layers under specified parameters. Then, the solutions in each layer are adjusted to satisfy boundary conditions between the layers. For this, a matrix of boundary conditions equations is filled which is then inverted using exact noniterative algorithm of matrix inversion. As a result of this inversion free factors of the analytic solutions written for each layer are determined. The full solution calculated correct for all the layers simultaneously is transformed by means of inverse fast Fourier transform to calculate target displacements and stress in Cartesian space.

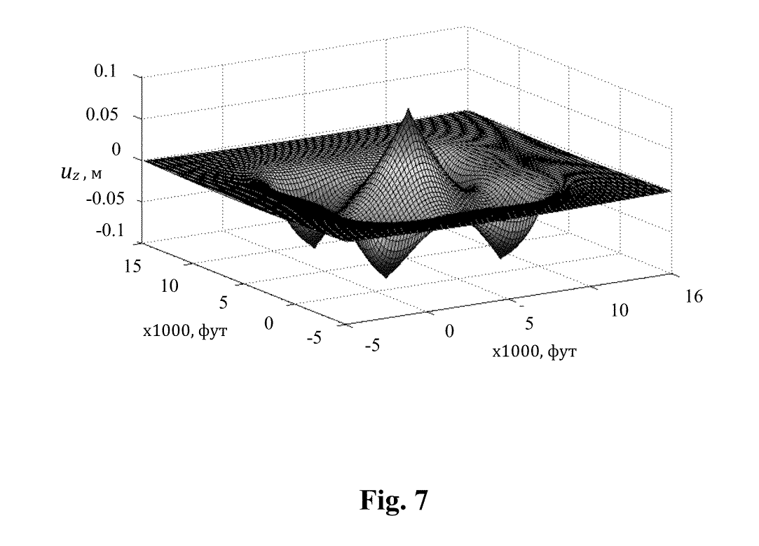

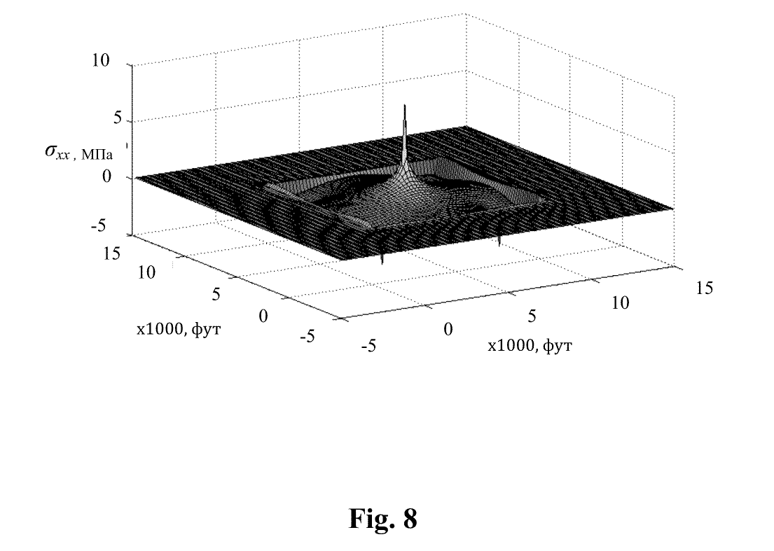

Examples of calculated vertical displacements and normal tensor tensions components in direction of one of horizontal coordinates' axis, which were obtained for above-mentioned input parameters, are shown on FIG. 7 and FIG. 8. On FIG. 7 and FIG. 8 it is seen that maximum values of said components of displacements and stresses are achieved near operating wells. Thus, vertical displacements u_{z} are about −9.5 cm near the production wells and about 8 cm near the injection well. A tension tensor component σₓₓ is about 4.2 MPa near the production wells and about 7.8 MPa near the injection well.

Example of Input LGM File:

```
- Double hyphen means a commentary, chapter end is marked with
“/” at the end of a line
- Maximum length of a line is 256 symbols
-Links to output file and executed file GREAT are defined
FILE /
  OUTPUT_FILE “out.txt” /
  GREAT_EXE
“D:\MyDocuments\GREAT\GREATV2_1_2\
KeywordInputFileExe\Release\great.exe” /
/
-Computational grid is defined in XY plane. NX, NY - quantity of points
where a pressure is specified in each coordinate direction
- DX, DY (ft) - a grid step. X(Y)_MARGIN - coefficients defining ratio
between a distance from boundary of the collector to an external boundary
and size of the collector
- Full grid contains (2*X_MARGIN+1)*NX x (2*Y_MARGIN+1)*NY
points,
- In a central block of NX x NY points pressures values are specified
DIMENSIONS
  NX 50 /
  NY 50 /
  DX 200 /
  DY 200 /
  X_MARGIN 2 /
  Y_MARGIN 2 /
/
- Define properties of a separate layer of the geologic model and pressure
change in Z direction
- DZ (ft) 0=Inf, E (GPA), PR (1), p1−p3 (1).
p(x,y,z)=p0(x,y)*(1+p1*z+p2*z\hat{ }2+p3*z\hat{ }3)
- PRESSURE_LOAD 0.0-1.0 - a pore pressure value applied to the
layer, 0-pressure loading is absent
LAYER /
  DZ 6800 /
  YOUNG_MODULUS 10 /
  POISSON_RATIO 0.25 /
  P1 0.0 /
  P2 0.0 /
  P3 0.0 /
  PRESSURE_LOAD 0 /
/
LAYER /
  DZ 267 /
  YOUNG_MODULUS 2 /
  POISSON_RATIO 0.35 /
  P1 0.0 /
  P2 0.0 /
  P3 0.0 /
  PRESSURE_LOAD 1 /
  SOURCE_TYPE GREAT /
  SOURCE_FILE “5spot_GR_top.txt” /
- SOURCE_TYPE TXT /
- SOURCE_FILE “DP_top.txt” /
/
LAYER /
  DZ 33 /
  YOUNG_MODULUS 2 /
  POISSON_RATIO 0.35 /
  P1 0.0 /
  P2 0.0 /
  P3 0.0 /
  PRESSURE_LOAD 0 /
/
LAYER /
  DZ 400 /
  YOUNG_MODULUS 2 /
  POISSON_RATIO 0.35 /
  P1 0.0 /
  P2 0.0 /
  P3 0.0 /
  PRESSURE_LOAD 1 /
  SOURCE_TYPE GREAT /
  SOURCE_FILE “5spot_GR_btm.txt” /
/
LAYER /
  DZ 0 /
  YOUNG_MODULUS 10 /
  POISSON_RATIO 0.25 /
  P1 0.0 /
  P2 0.0 /
  P3 0.0 /
  PRESSURE_LOAD 0 /
/
- Coordinates of the layers are determined for data output
OUTPUT
  Z 0 /
  Z -1000 /
  Z -2000 /
  Z -3000 /
  Z -4000 /
  Z -5000 /
  Z -6000 /
  Z -6400 /
  Z -6600 /
  Z -6800 /
  Z -6850 /
  Z -6900 /
  Z -7000 /
  Z -7100 /
  Z -7200 /
  Z -7300 /
  Z -7400 /
  Z -7500 /
  Z -7600 /
  Z -7800 /
  Z -8000 /
  Z -8500 /
  Z -9000 /
/
```

An example of input file “5spot_GR_top.txt” defining pressure calculation by means of GREAT in a top porous layer being developed. An input file for a bottom layer “5 spot_GR_btm.txt” is similar.

```
- GIVES TIMESTEP INFORMATION
TIMESTEP /
- STEP DURATION(days) NUMBER_OF_STEPS
  STEP 1440 1 /
/
- GIVES STANDARD CONDITIONS
STANDARD /
- PRESSURE STANDARD_PRESSURE(psi)
  PRESSURE 14.7 /
- TEMPERATURE STANDARD_TEMPERATURE(C)
  TEMPERATURE 15.555556 /
/
- GIVES DEPTH TO TOP OF FIELD
TOP /
  6800.0 /
/
- GIVES INFORMATION AT A DATUM DEPTH
DATUM /
- DEPTH DATUM_DEPTH(ft)
  DEPTH 6800.0 /
- PRESSURE DATUM_PRESSURE(psi)
  PRESSURE 4500.0 /
- DATUM_TEMPERATURE(C)
  TEMP 93.333 /
/
- SPECIFIES PRIMARY PRODUCTION PHASE
PHASE /
  OIL /
/
- GIVES THE EXTENT OF THE FIELD
EXTENT /
- LENGTH(ft) WIDTH(ft)
  10000.0 10000.0 /
/
- DEFINES A LAYER WITH ITS ROCK AND FLUID PROPERTIES
LAYER /
  POROSITY 0.2 /
  PERMXY 0.5 /
  PERMZ 0.5 /
  DZ 266.67 /
  OIL /
    VISCOSITY 0.9 /
    COMPR 5.33e−6 /
    FVF 1.05 /
  /
/
- DEFINES A WELL. PERFORATIONS AND FRACTURES AND
THE WELL RATES ARE DEFINED HERE
WELL P-1 /
- perf x1(ft) y1(ft) z1(ft) x2(ft) y2(ft) z2(ft)
  perf 1500.0 1500.0 6800.0 1500.0 1500.0 7066.67 radius 10 /
  RATE /
  - TIME(days) GAS_RATE(Mscf/d) OIL_RATE(bbl/d)
  0.0 0.0 200 /
  /
/
  WELL P-2 /
  perf 8500.0 1500.0 6800.0 8500.0 1500.0 7066.67 radius 10 /
  RATE /
    0.0 0.0 200 /
  /
/
WELL P-3 /
  perf 1500.0 8500.0 6800.0 1500.0 8500.0 7066.67 radius 10 /
  RATE /
    0.0 0.0 200 /
  /
/
WELL P-4 /
  perf 8500.0 8500.0 6800.0 8500.0 8500.0 7066.67 radius 10 /
  RATE /
    0.0 0.0 200 /
  /
/
WELL INJ /
  perf 5100.0 5100.0 6800.0 5100.0 5100.0 7066.67 radius 10 /
  RATE /
    0.0 0.0 −400 /
  /
/
```

The invention industrial applicability of the invention is confirmed by the above example of the method's embodiment and also by ability of its realization using technologic equipment and materials wide-known in industry and others branches.

What is claimed is:

1. A method for determining a stress-deformed state of a layered medium, the method comprising:
determining initial parameters of a layered medium,
determining a volume-distributed loading of developed layers of the layered medium,
specifying a set of equations comprising elastic balance equations for each layer and equations defining boundary conditions between the layers, the boundary conditions comprising continuity of fractions between the layers, zero tractions at free boundaries and zero displacements at infinity,
obtaining analytical solutions of the elastic balance equations for each layer provided that the layers are plane-parallel, homogenous and poroelastic,
adjusting the analytical solutions obtained for the layers taking into account corresponding boundary conditions, and
determining displacements and stresses in selected points of the layered medium in accordance with an approximation accuracy on the basis of the adjusted analytical solutions.

2. The method of claim 1, wherein the initial parameters comprise geologic parameters of the layers.

3. The method of claim 2, wherein the geologic parameters of the layers comprise Lame elastic parameters (λ, μ), Biot poroelastic constant and a thickness of a layer.

4. The method of claim 3, wherein the geologic parameters are determined by means of measuring tools or empirically or both, or are selected in dependence of a current task.

5. The method of claim 1, wherein the volume-distributed loading is determined through a pore pressure gradient of the layer being developed.

6. The method of claim 6, wherein the pore pressure is calculated by solving a piezoconductivity equation with a semi-analytic hydrodynamic method.

7. The method of claim 1, wherein steps of adjusting the analytical solutions obtained for the layers and of determining displacements and stresses in selected points of the layered medium are realized in Cartesian coordinates.

8. The method of claim 1, wherein steps of adjusting the analytical solutions obtained for the layers and of determining displacements and stresses in selected points of the layered medium are realized in cylindrical coordinates.

9. The method of claim 1, wherein the obtained stresses and displacements are visualized.
